(19) United States
(12) Patent Application Publication
(10) Pub. No.: US 2026/0148356 A1
(43) Pub. Date: May 28, 2026

(54) IMAGE PROCESSING APPARATUS AND IMAGE PROCESSING METHOD

(71) Applicant: CANON KABUSHIKI KAISHA, Tokyo (JP)

(72) Inventor: RYOSUKE TAKAHASHI, Kanagawa (JP)

(21) Appl. No.: 19/384,292

(22) Filed: Nov. 10, 2025

(30) Foreign Application Priority Data
Nov. 26, 2024 (JP) 2024-205700

(51) Int. Cl. G06T 5/90; G06T 5/50

(52) U.S. Cl. CPC G06T 5/90; G06T 5/50; G06T 2207/10024; G06T 2207/20208; G06T 2207/20221

(57) ABSTRACT

An image processing apparatus obtains a plurality of first images and a plurality of second images each having a format different from a format of each of the plurality of first images and each having a correspondence with each of the plurality of first images, generates a first combined image and a second combined image by combining images having the same format among the plurality of first images and the plurality of second images, and generates, from the first combined image and the second combined image, conversion information of a combined image for mutually converting the first combined image and the second combined image.

### BACKGROUND

### Field of the Technology

The present disclosure relates to image processing of generating conversion information to be used to obtain an image in a different format.

### Description of the Related Art

Conventionally, an image in a High Dynamic Range (HDR) format and an image in a Standard Dynamic Range (SDR) format have mutually been converted using conversion information called a gain map so as to be suitable for the dynamic range that can be displayed by a display device (Eric Chan□ “Gain Maps” Version 1.0 draft 15″, [online], Feb. 28, 2024, [searched on May 15, 2024], Internet <URL □ https:/helpx.adobe.com/content/dam/help/en/camera-raw/using/gain-map/ jcr_content/root/content/flex/items/position/position-par/table/row-3u03dx0-column-4a63daf/download_section/download-1/Gain_Map_1_0d15.pdf>).

Japanese Patent Laid-Open No. 2015-142276 describes that an image with a wide dynamic range or color gamut is generated with a low processing load based on base image data and a difference data used in processing of enlarging the dynamic range or color gamut of image data.

When combining images to which gain maps are attached, the gain maps attached to the images before combining do not exist for a combined image, and it is thus difficult to mutually convert images in different formats. Japanese Patent Laid-Open No. 2015-142276 does not mention a gain map considering processing for combining images to which gain maps are attached.

### SUMMARY

The present disclosure has been made in consideration of the aforementioned problems, and provides technical advantages in generating conversion information suitable for a combined image obtained by combining a plurality of images each provided with conversion information to be used to generate an image in a different format.

In order to solve the aforementioned problems, the present disclosure is directed to an image processing apparatus comprising: one or more processors; and a memory storing instructions which, when the instructions are executed by the one or more processors, cause the image processing apparatus to function as: an obtaining unit that obtains a plurality of first images and a plurality of second images each having a format different from a format of each of the plurality of first images and each having a correspondence with each of the plurality of first images; a combining unit that generates a first combined image and a second combined image by combining images having the same format among the plurality of first images and the plurality of second images; and a generation unit that generates, from the first combined image and the second combined image, conversion information of a combined image for mutually converting the first combined image and the second combined image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying an apparatus configuration according to a first embodiment;

FIG. 2 is a view illustrating image files according to the first embodiment;

FIG. 3 is a view illustrating image conversion processing according to the first embodiment;

FIG. 4 is a view illustrating image combining processing according to the first embodiment;

FIG. 5 is a view illustrating gain map generation processing according to the first embodiment;

FIG. 6 is a view illustrating a combined image file according to the first embodiment;

FIG. 7 is a block diagram exemplifying an apparatus configuration according to a second embodiment;

FIG. 8 is a view illustrating image files according to the second embodiment;

FIG. 9 is a view illustrating image conversion processing according to the second embodiment; and

FIG. 10 is a view illustrating image combining processing according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

This embodiment will describe an embodiment in which an image processing apparatus according to the present disclosure is applied to an information processing apparatus such as a personal computer (PC) or an information processing terminal such as a smart device or a tablet PC. However, the present disclosure is not limited to this, and the image processing apparatus according to the present disclosure may be applied to an image capture apparatus such as a digital camera that can shoot an image.

### First Embodiment

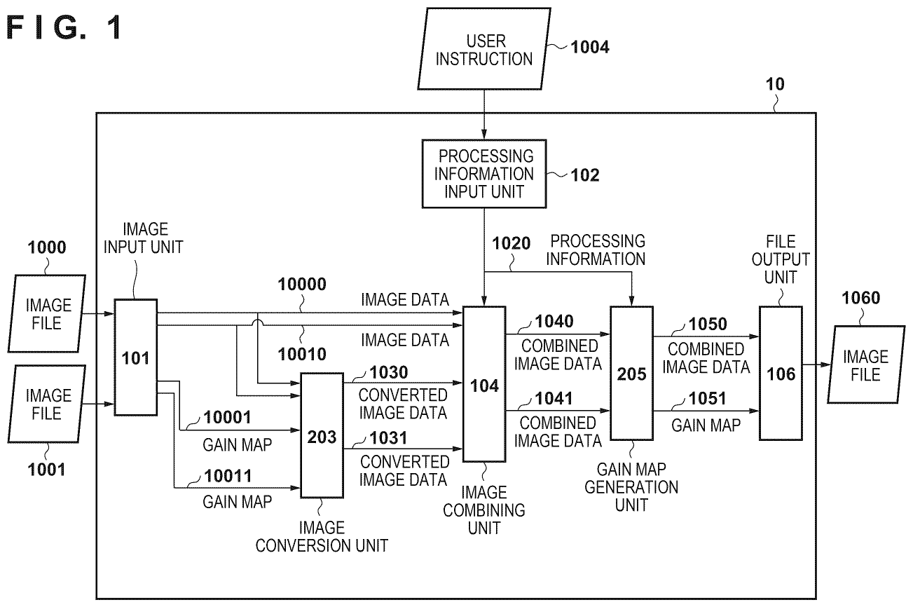

The configuration and function of an image processing apparatus 10 according to the first embodiment will be described first with reference to FIG. 1.

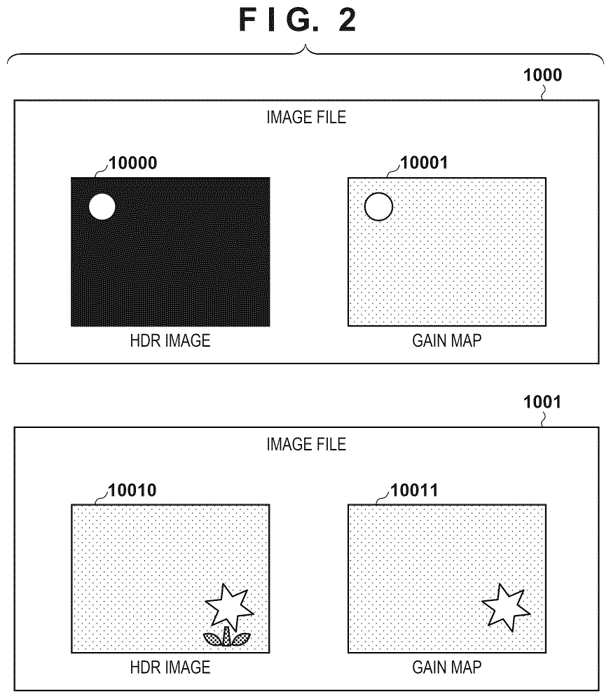

FIG. 1 is a block diagram exemplifying the functional configuration of the image processing apparatus 10 according to the first embodiment. FIG. 2 is a view illustrating image files according to the first embodiment.

The respective function blocks of the image processing apparatus 10 according to the first embodiment, except for a portion that can be implemented by only hardware, can be implemented by software or a combination of software and hardware. For example, each function block may be implemented by dedicated hardware such as an ASIC. Alternatively, each function block may be implemented when a processor such as a CPU or a GPU executes a program stored in a memory. Note that a plurality of function blocks may be implemented by a common component (for example, one ASIC). Hardware that implements the function of a part of a given function block may be included in hardware that implements another function block.

The image processing apparatus 10 inputs a plurality of image files each including image data and a gain map attached to the image data, and performs combining processing of the input image data, thereby generating combined image data. Then, the image processing apparatus 10 generates a gain map for a combined image, and assigns it to the combined image data, thereby outputting the thus obtained data as an image file.

The gain map is conversion information for mutually converting an image (HDR image) in the High Dynamic Range (HDR) format and an image (SDR image) in the Standard Dynamic Range (SDR) format so as to be suitable for the dynamic range that can be displayed by a display device. The format of the gain map includes a multi-channel or color channel (3-channel) format and a monochrome channel (1-channel) format. The number of channels of the gain map is not limited to one or three.

The image processing apparatus 10 includes an image input unit 101, a processing information input unit 102, an image conversion unit 103, an image combining unit 104, a gain map generation unit 105, and a file output unit 106.

The image input unit 101 is a function block that inputs image files 1000 and 1001 from an external apparatus such as a camera. The image file 1000 includes image data 10000 and a gain map 10001 attached to the image data 10000. The image file 1001 includes image data 10010 and a gain map 10011 attached to the image data 10010. The image data 10000 and 10010 are image data of HDR images. The gain maps 10001 and 10011 are gain maps used for processing of mutually converting an HDR image and an SDR image.

In this embodiment, the HDR image is an image with a dynamic range wider than that of the SDR image, and is, for example, a YUV image applied with the Electro-Optical Transfer Function (EOTF) characteristic described in ST2084 or the like as an HDR standard with which a display device capable of displaying the HDR image complies. The SDR image is a YUV image with a dynamic range narrower than that of the HDR image, and is, for example, a YUV image applied with the sRGB gamma characteristic. This embodiment assumes that the gamma characteristic of the HDR image is HDR gamma, the gamma characteristic of the SDR image is SDR gamma, and the color gamut is common.

In this embodiment, the gain map is 1-channel data including gain information for pixels, the number of which is equal to the number of pixels of the image to which the gain map is attached. The gain map according to this embodiment is obtained by applying degamma to each of an HDR image and an SDR image and recording, for each pixel, the ratio of the Y components of the HDR image and the SDR image. To convert an HDR image into an SDR image, after degamma is applied to the HDR image, the Y component of each pixel is changed with reference to the gain of the gain map, and then SDR gamma is applied, thereby converting the HDR image into the SDR image. Conversely, to convert an SDR image into an HDR image, after degamma is applied to the SDR image, the Y component of each pixel is changed with reference to the gain of the gain map, and then HDR gamma is applied, thereby converting the SDR image into the HDR image.

In this embodiment, the plurality of input image files are files each including HDR image data and a gain map but may be files each including SDR image data and a gain map. The gain map according to this embodiment is not limited to the structure of the gain map having the number of pixels equal to that of the image. For example, the gain map may include the number of pixels obtained by reducing the image, and may be scaled to the number of pixels equal to that of the image at the time of use and then used. This embodiment assumes that the resolutions of the image data 10000 and 10010 are equal to each other but may be different. In addition, in this embodiment, the gain of each pixel of the gain map is generated based on the ratio of the Y values after applying degamma to an HDR image and an SDR image but the generation method is not limited to this. For example, an HDR image is converted into an RGB image applied with HDR gamma, an SDR image is converted into an RGB image applied with SDR gamma, and the ratio of the R, G, or B values may be used. The gain map according to this embodiment is 1-channel data whose number of channels is one. However, the present disclosure is not limited to this, and for example, the gain map may be 3-channel data including gain information corresponding to each of color components of R (red), G (green), and B (blue) of the RGB image. In this embodiment, the two image files are input but three or more image files may be input.

The image input unit 101 outputs the image data 10000 included in the image file 1000 and the image data 10010 included in the image file 1001 to the image conversion unit 103 and the image combining unit 104. Furthermore, the image input unit 101 outputs the gain map 10001 included in the image file 1000 and the gain map 10011 included in the image file 1001 to the image conversion unit 103.

FIG. 2 exemplifies the image file 1000, the image data 10000, the gain map 10001, the image file 1001, the image data 10010, and the gain map 10011 according to the first embodiment. Referring to FIG. 2, it is indicated that each region of the images of the image data 10000 and 10010 has higher luminance as it is closer to white, and has lower luminance as it is closer to black. A white portion of each of the gain maps 10001 and 10011 indicates a region where there is a difference between the Y components of the HDR image and the SDR image, and a hatched portion indicates a region where the Y components of the HDR image and the SDR image are the same.

The processing information input unit 102 is a function block that accepts, from a user, a user instruction 1004 that designates processing contents.

The processing information input unit 102 includes, for example, a display that displays, to the user, the kind of combining processing and the type of the file format of a combined image after the combining processing, and a mouse or a touch panel that accepts a user instruction. The user instructs, via the processing information input unit 102, the kind of image combining processing, the file format of a combined image obtained by performing the combining processing, and the like. The processing information input unit 102 outputs, to the image combining unit 104 and the gain map generation unit 105, processing information 1020 corresponding to the user instruction 1004.

The image conversion unit 103 is a function block that obtains, using image data and a gain map, image data having a correspondence with the image data and a different format. When the input image is an HDR image, it is converted into an SDR image, and when the input image is an SDR image, it is converted into an HDR image.

After applying degamma to the input HDR image, the image conversion unit 103 converts the Y component for each pixel of the image based on information described in the gain map, and applies SDR gamma, thereby converting the HDR image into an SDR image.

In this embodiment, by using the image data 10000 as the HDR image and the gain map 10001, converted image data 1030 as an SDR image is generated. Furthermore, by using the image data 10010 as the HDR image and the gain map 10011, converted image data 1031 as an SDR image is generated.

The image conversion unit 103 outputs the generated converted image data 1030 and converted image data 1031 to the image combining unit 104. This embodiment assumes that each converted image data includes information indicating specific image data from which the converted image data is converted.

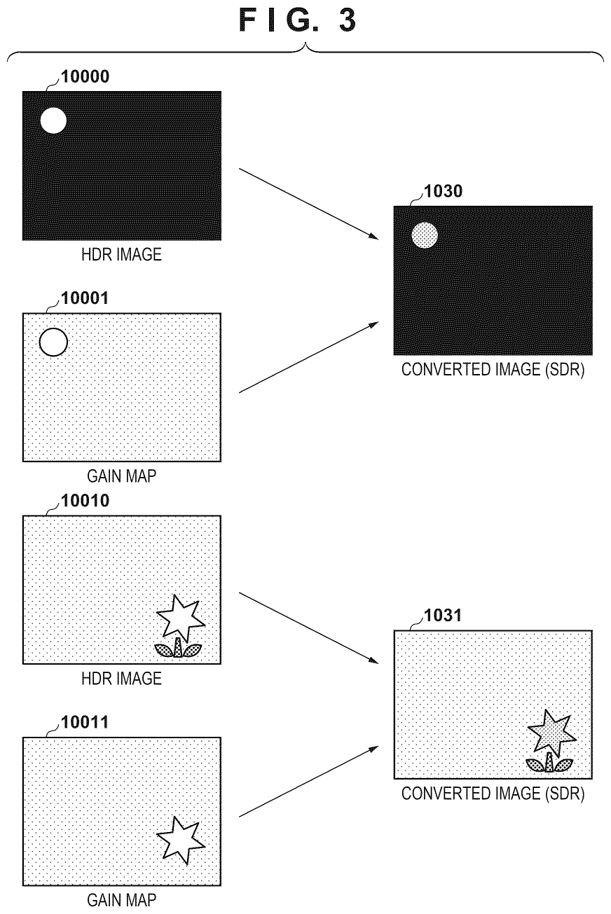

FIG. 3 is a view illustrating the image conversion processing according to the first embodiment.

In this embodiment, a region where there is a color difference between the image data 10000 as the HDR image and the converted image data 1030 as the SDR image indicates a portion where the Y component changes when conversion between the HDR image and the SDR image is performed. Similarly, a region where there is a color difference between the image data 10010 as the HDR image and the converted image data 1031 as the SDR image indicates a portion where the Y component changes when conversion between the HDR image and the SDR image is performed.

The image combining unit 104 is a function block that generates, using the input image data 10000, image data 10010, converted image data 1030, and converted image data 1031, a combined image based on information described in the processing information 1020.

The image combining unit 104 identifies the data having the same image format from the input image data 10000, image data 10010, converted image data 1030, and converted image data 1031. In this embodiment, as the image format, whether the image data is the HDR image or the SDR image is identified. This embodiment assumes that the image data 10000 and 10010 are identified as the HDR images having the same image format, and the converted image data 1030 and 1031 are identified as the SDR images having the same image format.

The image combining unit 104 selects a method of combining images, based on the information described in the processing information 1020. In this embodiment, lighten composition is selected as the combining method to compare the respective pixels of the images to be combined, and the brighter pixel is adopted as the pixel of a combined image. The first embodiment assumes that the combined image has the same resolution and format as those of the images used for combining.

Next, the image combining unit 104 compares the Y values with each other for pixels at the identical coordinates in the image data 10000 and 10010. Then, the pixel value of the pixel having the larger Y value is selected as a pixel value at the identical coordinates in a combined image, thereby generating combined image data 1040 as the combined image of the HDR images.

Furthermore, the image combining unit 104 compares the Y values with each other for pixels at the identical coordinates in the converted image data 1030 and 1031. Then, the pixel value of the pixel having the larger Y value is selected as a pixel value at the identical coordinates in a combined image, thereby generating combined image data 1041 as the combined image of the SDR images.

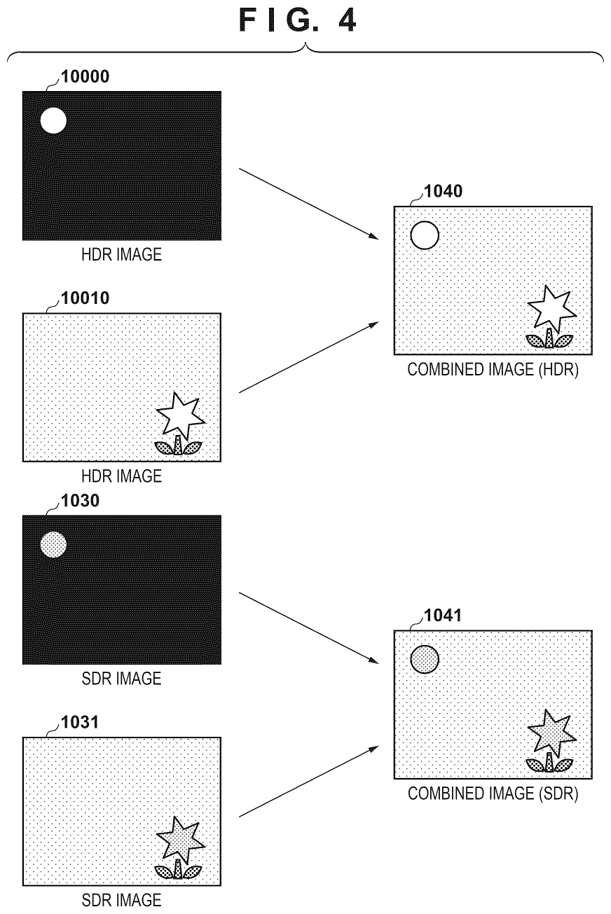

FIG. 4 is a view illustrating the image combining processing according to the first embodiment.

Referring to FIG. 4, it is indicated that each region of the images of the image data 10000, the image data 10010, the combined image data 1040, the converted image data 1030, the converted image data 1031, and the combined image data 1041 has higher luminance as it is closer to white, and has lower luminance as it is closer to black.

The image combining unit 104 outputs the generated combined image data 1040 and 1041 to the gain map generation unit 105.

The gain map generation unit 105 is a function block that generates, using the input combined image data 1040 and 1041, a gain map based on the information described in the processing information 1020.

The first embodiment assumes that the processing information 1020 includes information indicating that the image format of the output combined image data is HDR and the format of the output gain map is 1-channel data for converting the Y component of each pixel.

The gain map generation unit 105 applies degamma to each of the combined image data 1040 as the HDR image and the combined image data 1041 as the SDR image and records the ratio of the Y components for each pixel, thereby generating a gain map 1051.

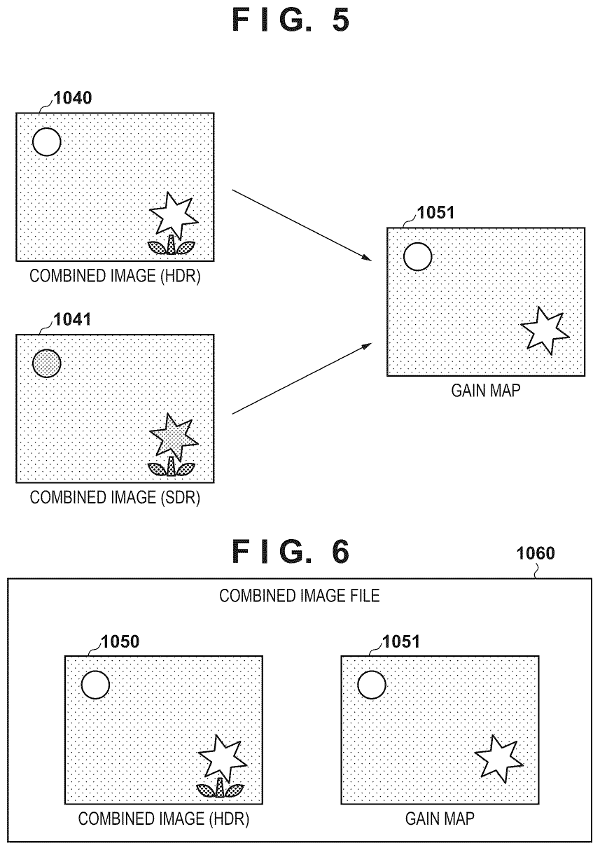

FIG. 5 is a view illustrating the gain map generation processing according to the first embodiment.

Referring to FIG. 5, a region where there is a color difference between the combined image data 1040 as the HDR image and the combined image data 1041 as the SDR image indicates a portion where there is a difference in the Y value when comparing the image data each obtained by applying degamma. Furthermore, referring to FIG. 5, a white portion of the gain map 1051 indicates a region where there is a difference between the Y components of the HDR image and the SDR image and a hatched portion indicates a region where the Y components of the HDR image and the SDR image are the same.

The gain map generation unit 105 outputs, to the file output unit 106, as combined image data 1050, one of the input combined image data 1040 and 1041, which matches the image format of the combined image data described in the processing information 1020. In addition, the gain map generation unit 105 outputs the gain map 1051 to the file output unit 106.

The file output unit 106 is a function block that outputs an image file to the outside of the image processing apparatus 10. The file output unit 106 outputs, as a combined image file 1060, a file obtained by assigning the gain map 1051 to the input combined image data 1050. FIG. 6 is a view illustrating the combined image file 1060 according to the first embodiment.

Note that the first embodiment has described an example in which the input image files have the same format (HDR images) and the formats (the numbers of channels) of the gain maps attached to the image files are the same. However, the same applies to a case where the input image files have different formats (the HDR image and the SDR image) and the formats (the numbers of channels) of the gain maps attached to the image files are different from each other. In this case, a combined image is generated by combining the input HDR image and an HDR image converted from the input SDR image, and a combined image is generated by combining the input SDR image and an SDR image converted from the input HDR image, thereby generating a gain map for a combined image.

As described above, according to the first embodiment, in a case where images with attached gain maps are combined, it is possible to generate a gain map suitable for a combined image.

### Second Embodiment

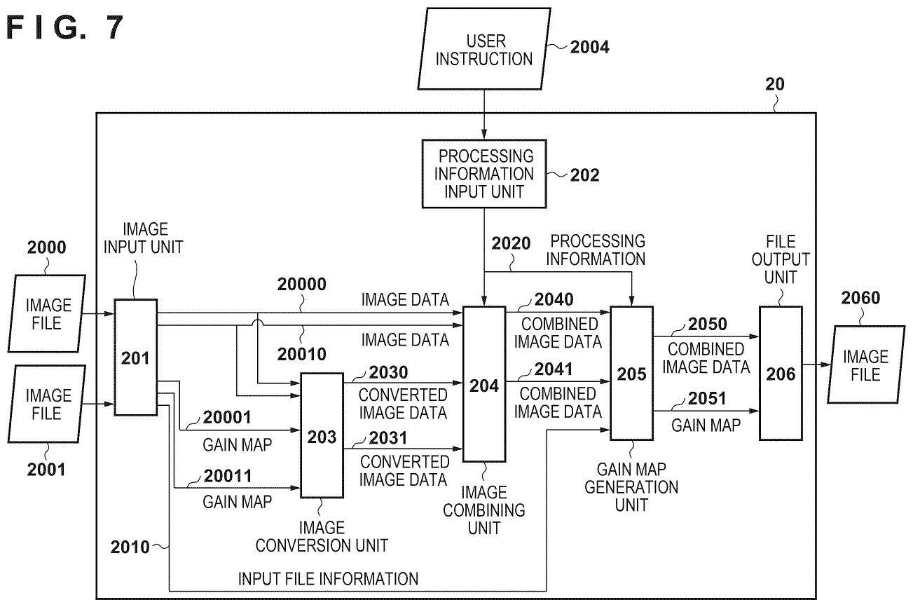

The second embodiment will be described next with reference to FIGS. 7 to 10.

First, the configuration and function of an image processing apparatus 20 according to the second embodiment will be described with reference to FIG. 7.

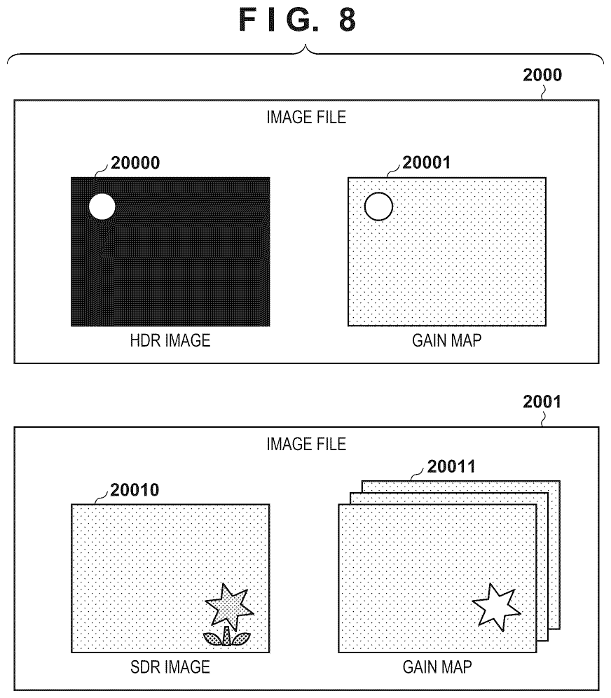

FIG. 7 is a block diagram exemplifying the functional configuration of the image processing apparatus 20 according to the second embodiment. FIG. 8 is a view illustrating image files according to the second embodiment.

The image processing apparatus 20 according to the second embodiment inputs a plurality of image files each including image data and a gain map attached to the image data, and performs combining processing of the input images, thereby generating a combined image. Then, the image processing apparatus 20 outputs an image file obtained by generating a gain map for the combined image and assigning it to the combined image data.

The image processing apparatus 20 includes an image input unit 201, a processing information input unit 202, an image conversion unit 203, an image combining unit 204, a gain map generation unit 205, and a file output unit 206.

The image input unit 201 is a function block that inputs image files 2000 and 2001 from an external apparatus such as a camera. The image file 2000 includes image data 20000 and a gain map 20001 attached to the image data 20000. The image file 2001 includes image data 20010 and a gain map 20011 attached to the image data 20010.

In the second embodiment, the image file 2000 is a file including HDR image data and a gain map, and the image file 2001 is a file including SDR image data and a gain map. The gain map 20001 is 1-channel data including gain information for Y components of pixels, the number of which is equal to the number of pixels of the image to which the gain map is attached. Furthermore, the gain map 20011 is 3-channel data including gain information for R components, G components, and B components of pixels, the number of which is equal to the number of pixels of the image to which the gain map is attached.

The image input unit 201 outputs the image data 20000 included in the image file 2000 and the image data 20010 included in the image file 2001 to the image conversion unit 203 and the image combining unit 204. The image input unit 201 outputs the gain map 20001 included in the image file 2000 and the gain map 20011 included in the image file 2001 to the image conversion unit 203. The image input unit 201 outputs, to the gain map generation unit 205, as input file information 2010, information concerning the formats of the image data 20000, the image data 20010, the gain map 20001, and the gain map 20011.

FIG. 8 exemplifies the image file 2000, the image data 20000, the gain map 20001, the image file 2001, the image data 20010, and the gain map 20011 according to the second embodiment. Referring to FIG. 8, it is indicated that each region of the images of the image data 20000 and 20010 has higher luminance as it is closer to white, and has lower luminance as it is closer to black. A white portion of the gain map 20001 indicates a region where there is a difference between the Y components of the HDR image and the SDR image, and a hatched portion indicates a region where the Y components of the HDR image and the SDR image are the same. The gain map 20011 includes three gain maps of the R component, the G component, and the B component. A white portion indicates a region where there is a difference in at least one of the R component, the G component, and the B component between the HDR image and the SDR image.

The processing information input unit 202 is a function block that accepts, from a user, a user instruction 2004 that designates processing contents.

The processing information input unit 202 includes, for example, a display that displays, to the user, the kind of combining processing and the type of the file format of a combined image after the combining processing, and a mouse or a touch panel that accepts a user instruction. The user instructs the kind of image combining processing using the processing information input unit 202.

The processing information input unit 202 outputs, to the image combining unit 204, processing information 2020 corresponding to the user instruction 2004.

The image conversion unit 203 is a function block that obtains, using image data and a gain map, image data having a correspondence with the image data and a different format. When the input image is an HDR image, it is converted into an SDR image, and when the input image is an SDR image, it is converted into an HDR image.

In this embodiment, the image data 20000 is an HDR image and the gain map 20001 is 1-channel data including gain information for the Y component. In this embodiment, after applying degamma to the image data 20000, the Y component is converted for each pixel of the image based on information described in the gain map, and applies SDR gamma, thereby generating converted image data 2030 as an SDR image.

Furthermore, the image data 20010 is an SDR image and the gain map 20011 is 3-channel data including gain information for the R component, the G component, and the B component. In this embodiment, after applying degamma to the image data 20010, the YUV components of each pixel are converted into RGB components. Then, each of the R component, the G component, and the B component is converted for each pixel of the image based on the information described in the gain map. After the converted RGB components are converted into YUV components, HDR gamma is applied to generate converted image data 2031 as an HDR image.

The image conversion unit 203 outputs the generated converted image data 2030 and 2031 to the image combining unit 204. This embodiment assumes that each converted image data includes information indicating specific image data from which the converted image data is converted.

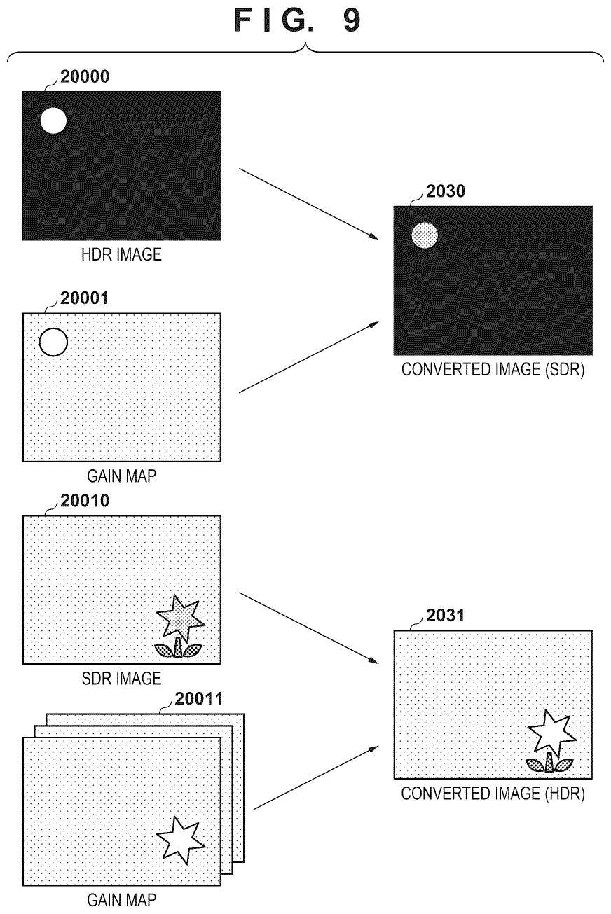

FIG. 9 is a view illustrating the image conversion processing according to the second embodiment.

Referring to FIG. 9, a region where there is a color difference between the image data 20000 as the HDR image and the converted image data 2030 as the SDR image indicates a portion where the Y component changes when conversion between the HDR image and the SDR image is performed. A region where there is a color difference between the image data 20010 as the SDR image and the converted image data 2031 as the HDR image indicates a portion where the Y component changes due to the change of at least one of the R component, the G component, and the B component caused when conversion between the SDR image and the HDR image is performed.

The image combining unit 204 is a function block that generates, using the input image data 20000, image data 20010, converted image data 2030, and converted image data 2031, a combined image based on information described in the processing information 2020.

The image combining unit 204 identifies the data having the same image format from the input image data 20000, image data 20010, converted image data 2030, and converted image data 2031. In this embodiment, as the image format, whether the image data is the HDR image or the SDR image is identified. This embodiment assumes that the image data 20000 and the converted image data 2031 are identified as the HDR images having the same image format, and the image data 20010 and the converted image data 2030 are identified as the SDR images having the same image format.

The image combining unit 204 selects a method of combining images, based on the information described in the processing information 2020. In this embodiment, lighten composition is selected as the combining method to compare the respective pixels of the images to be combined, and the brighter pixel is adopted as the pixel of a combined image. This embodiment assumes that the combined image has the same resolution and image format as those of the images used for combining.

Furthermore, the image combining unit 204 compares the Y values with each other for pixels at the identical coordinates in the image data 20000 and the converted image data 2031. Then, the pixel value of the pixel having the larger Y value is selected as a pixel value at the identical coordinates in a combined image, thereby generating combined image data 2040 as the combined image of the HDR images.

In addition, the image combining unit 204 compares the Y values with each other for pixels at the identical coordinates in the image data 20010 and the converted image data 2030. Then, the pixel value of the pixel having the larger Y value is selected as a pixel value at the identical coordinates in a combined image, thereby generating combined image data 2041 as the combined image of the SDR images.

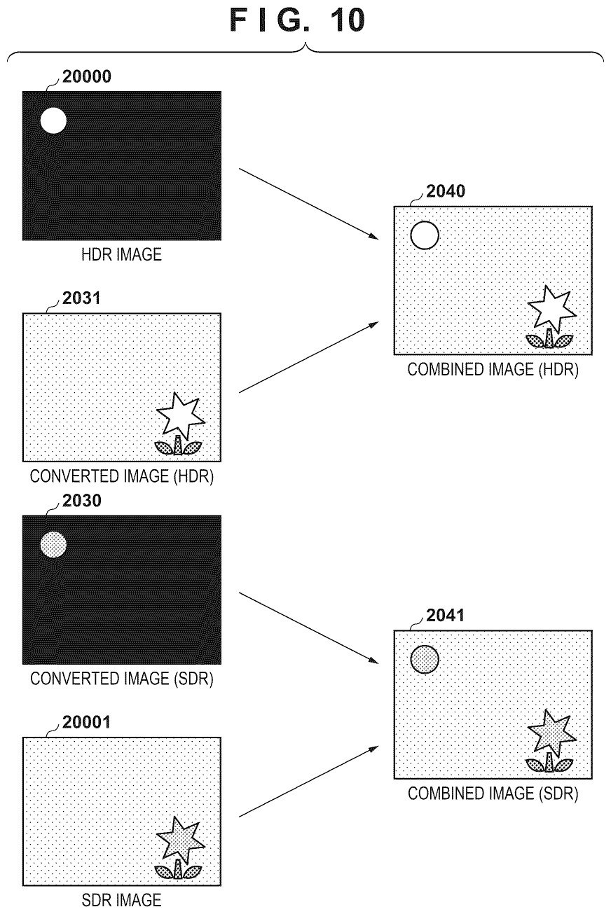

FIG. 10 is a view illustrating the image combining processing according to the second embodiment.

Referring to FIG. 10, it is indicated that each region of the images of the image data 20000, the image data 20010, the combined image data 2040, the converted image data 2030, the converted image data 2031, and the combined image data 2041 has higher luminance as it is closer to white, and has lower luminance as it is closer to black.

The image combining unit 204 outputs the generated combined image data 2040 and 2041 to the gain map generation unit 205.

The gain map generation unit 205 is a function block that generates, using the input combined image data 2040 and 2041, a gain map based on information described in the processing information 2020 and the input file information 2010.

This embodiment assumes that the processing information 2020 includes information indicating that the image format of the output combined image data is HDR and the gain map generation unit 205 selects an HDR image as the image format of the combined image. Furthermore, in this embodiment, with reference to file information included in the input file information 2010, the gain map generation unit 205 selects, as the format of the gain map attached to the same image format as the image format of the combined image, 1-channel data including gain information for the Y component as the format of the generated gain map. In this embodiment, the method of selecting the image file format of the combined image is not limited to the above-described one, and for example, an HDR image may be selected on the assumption that higher quality can be expected or an SDR image may be selected on the assumption that more versatility is expected. The method of selecting the format of the generated gain map is not limited to the above-described one. For example, among the input file formats, 1-channel data including gain information for the Y component may be selected as a method of decreasing a file size, or 3-channel data including gain information for the R component, the G component, and the B component may be selected as a method of increasing a file size so that higher quality can be expected.

The gain map generation unit 205 applies degamma to each of the combined image data 2040 as the combined image of the HDR images and the combined image data 2041 as the combined image of the SDR images and records the ratio of the Y components for each pixel, thereby generating a gain map 2051.

The gain map generation unit 205 outputs, to the file output unit 206, as combined image data 2050, one of the input combined image data 2040 and 2041, which matches the image format of the combined image data described in the processing information 2020. In addition, the gain map generation unit 205 outputs the gain map 2051 to the file output unit 206.

The file output unit 206 is a function block that outputs an image file to the outside of the image processing apparatus 20, and outputs, as an image file 2060, a file obtained by assigning the gain map 2051 to the input combined image data 2050.

Note that the second embodiment has described an example in which the input image files and the gain maps have different formats (an HDR image to which a 1-channel gain map is attached and an SDR image to which a 3-channel gain map is attached). However, the same applies to a case where the input image files have the same format (HDR images or SDR images) and the formats of the gain maps are different from each other. In this case, SDR images or HDR images are generated from the input HDR images or SDR images, the input HDR images are combined to generate a combined image, and the SDR images converted from the input HDR images are combined to generate a combined image, thereby generating a gain map for a combined image.

As described above, according to the second embodiment, in a case where images with attached gain maps are combined, it is possible to generate a gain map suitable for a combined image.

The present disclosure may be applied to a system formed by a plurality of devices (a host computer, an interface device, an image capture apparatus, a WEB application, and the like) or an apparatus formed by a single device.

According to the present disclosure, it is possible to generate conversion information suitable for a combined image obtained by combining a plurality of images each provided with conversion information to be used to generate an image in a different format.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-205700, filed Nov. 26, 2024 which is hereby incorporated by reference herein in its entirety.

What is claimed is:

1. An image processing apparatus comprising:
one or more processors; and
a memory storing instructions which, when the instructions are executed by the one or more processors, cause the image processing apparatus to function as:
an obtaining unit that obtains a plurality of first images and a plurality of second images each having a format different from a format of each of the plurality of first images and each having a correspondence with each of the plurality of first images;
a combining unit that generates a first combined image and a second combined image by combining images having the same format among the plurality of first images and the plurality of second images; and
a generation unit that generates, from the first combined image and the second combined image, conversion information of a combined image for mutually converting the first combined image and the second combined image.

2. The apparatus according to claim 1, wherein each of the plurality of first images is provided with conversion information to be used to generate an image in a different format, and the obtaining unit obtains the plurality of second images by generating each of the plurality of second images in the different format from each of the plurality of first images.

3. The apparatus according to claim 1, wherein the one or more processors function as a selection unit that selects a format of the conversion information of the combined image.

4. The apparatus according to claim 3, wherein the selection unit selects the format of the conversion information of the combined image based on a format of the combined image.

5. The apparatus according to claim 3, wherein the selection unit selects, as the format of the conversion information of the combined image, a format that increases a file size out of a format of the conversion information attached to the first image and a format of conversion information attached to the second image.

6. The apparatus according to claim 3, wherein the selection unit selects, as the format of the conversion information of the combined image, a format that decreases a file size out of a format of the conversion information attached to the first image and a format of conversion information attached to the second image.

7. The apparatus according to claim 3, wherein the selection unit selects, as the format of the conversion information of the combined image, a format designated by a user.

8. The apparatus according to claim 7, wherein the selection unit selects, as the format of the conversion information of the combined image, the same format as a format of the combined image designated by the user.

9. The apparatus according to claim 3, wherein the format of the conversion information includes the number of channels corresponding to color components.

10. The apparatus according to claim 9, wherein
the formats of the plurality of first images are the same, and
the formats of the conversion information attached to the plurality of first images are the same in the number of channels.

11. The apparatus according to claim 9, wherein
the formats of the plurality of first images are different from each other, and
the formats of the conversion information attached to the plurality of first images are different in the number of channels.

12. The apparatus according to claim 11, wherein
the plurality of first images include a third image and a fourth image having different formats, and
the number of channels of a format of conversion information attached to the third image is larger than the number of channels of a format of conversion information attached to the fourth image.

13. The apparatus according to claim 12, wherein the format of the conversion information attached to the third image is a 3-channel format, and the format of the conversion information attached to the fourth image is a 1-channel format.

14. The apparatus according to claim 1, wherein the plurality of first images are images in a High Dynamic Range (HDR) format, and the plurality of second images are images in a Standard Dynamic Range (SDR) format.

15. The apparatus according to claim 1, wherein the plurality of first images are images in a Standard Dynamic Range (SDR) format, and the plurality of second images are images in a High Dynamic Range (HDR) format.

16. The apparatus according to claim 1, wherein the plurality of first images include an image in a High Dynamic Range (HDR) format and an image in a Standard Dynamic Range (SDR) format, and the plurality of second images include an image in the SDR format generated from the image in the HDR format among the first images and an image in the HDR format generated from the image in the SDR format among the first images.

17. The apparatus according to claim 1, wherein the conversion information is a gain map for mutually converting an image in a High Dynamic Range (HDR) format and an image in a Standard Dynamic Range (SDR) format.

18. An image processing method executed by an image processing apparatus comprising:
obtaining a plurality of first images and a plurality of second images each having a format different from a format of each of the plurality of first images and each having a correspondence with each of the plurality of first images;
generating a first combined image and a second combined image by combining images having the same format among the plurality of first images and the plurality of second images; and
generating, from the first combined image and the second combined image, conversion information of a combined image for mutually converting the first combined image and the second combined image.

19. A non-transitory computer-readable storage medium storing a program for causing a computer to function as an image processing apparatus comprising:
an obtaining unit that obtains a plurality of first images and a plurality of second images each having a format different from a format of each of the plurality of first images and each having a correspondence with each of the plurality of first images;
a combining unit that generates a first combined image and a second combined image by combining images having the same format among the plurality of first images and the plurality of second images; and
a generation unit that generates, from the first combined image and the second combined image, conversion information of a combined image for mutually converting the first combined image and the second combined image.
